(19) United States
(12) Patent Application Publication
(10) Pub. No.: US 2012/0132055 A1
(43) Pub. Date: May 31, 2012

(54) TREMOLO DEVICE

(76) Inventors: Gary N. Brinkley, JR., Champaign, IL (US); Jimmy Thackery, Eureka Springs, AR (US)

(21) Appl. No.: 13/308,040

(22) Filed: Nov. 30, 2011

Related U.S. Application Data
(60) Provisional application No. 61/418,129, filed on Nov. 30, 2010.

(51) Int. Cl. G10D 3/00

(52) U.S. Cl. 84/313

(57) ABSTRACT

A tremolo assembly for a stringed instrument, having a base plate detachably mounted to the stringed instrument. A string block is operatively attached to the base plate for movement about an axis, and secures strings of the instrument. A biasing mechanism attaches between the string block and the base plate for biasing the string block about the axis. A tremolo bar moveably attaches to the string block for movement of the tremolo assembly between a neutral position and a tremolo effect position.

### CROSS-REFERENCE TO RELATED APPLICATIONS

This Non-Provisional application claims priority to U.S. Provisional Application Ser. No. 61/418,129 filed Nov. 30, 2010, and which is incorporated herein by reference.

### STATEMENT REGARDING FEDERALLY SPONSORED RESEARCH

Not applicable.

### BACKGROUND OF THE INVENTION

For decades, musicians have used tremolo assemblies on stringed instruments, in particular electric guitars, to enhance the sound of the instrument. In general, a tremolo system includes a tremolo arm or “whammy bar” that is a lever attached to the bridge or the tailpiece of an electric guitar to enable the player to quickly vary the tension and sometimes the length of the strings temporarily, changing the pitch to create a vibrato, portamento, or pitch bend effect.

Over the years, various designs of tremolo assemblies have been employed, such as, the Bigsby® vibrato tailpiece, the Fender® synchronized tremolo, Fender® floating bridge, Fender® Dynamic Vibrato, Gibson® Vibrola, the Floyd Rose® locking tremolo, the Stetsbar, and the Schaller Tremelo LP. While these designs have enjoyed varying degrees of success and popularity among musicians, some of these designs require significant accommodations or modifications to the body of the instrument, such as, routing in the front face of the body, or creating a cavity in the rear of the body. Other replacement systems require the replacement of the original bridge and the stop tail piece. Due to the significant modifications and permanence of such designs, tremolo assemblies are typically factory installed, or require setup and intonation after installation.

Electric guitars that do not include a tremolo system are often referred to as “hard-tail” guitars. As mentioned above, installing a tremolo system on a hard-tail guitar requires significant and sometimes permanent modifications to the body. Owners of hard-tail guitars are often resistant to make such modifications, in particular, when the guitar is a vintage model or of significant value.

Therefore, there is a long-felt need for a tremolo assembly that can mount to a musical instrument without modifications to the body and without replacing the original bridge and stop tail piece.

### DESCRIPTION OF THE DRAWINGS

In the accompanying drawings which form part of the specification:

FIG. 1 is a perspective view of an electric guitar without a tremolo assembly;

FIG. 2 is a enlarged front view of a body of the electric guitar without the tremolo assembly and strings;

FIG. 3 is a front view of a tremolo assembly;

FIG. 4 is a front view of the tremolo assembly mounted on an electric guitar;

FIG. 5 is a side view of the tremolo assembly mounted on the electric guitar;

FIG. 6 is an end view of the tremolo assembly mounted on the electric guitar;

FIG. 7 is a perspective view of an electric guitar without an alternate tremolo assembly;

FIG. 8 is a is a front view of an alternate embodiment of the tremolo assembly mounted on an electric guitar;

FIG. 9 is a side view of the alternate embodiment of the tremolo assembly mounted on the electric guitar;

FIG. 10 is an end view of the alternate embodiment of the tremolo assembly mounted on the electric guitar;

FIG. 11 is an enlarged end view of the alternate embodiment of the tremolo assembly mounted on the electric guitar;

FIG. 12 is a perspective view of a string block;

FIG. 13 is a perspective view of a base plate;

FIG. 14 is a perspective view of a hinge; and

FIG. 15 is a perspective view of a lower member.

Corresponding reference numerals indicate corresponding parts throughout the several figures of the drawings.

### DETAILED DESCRIPTION

The following detailed description illustrates the claimed invention by way of example and not by way of limitation. The description clearly enables one skilled in the art to make and use the claimed invention, describes several embodiments, adaptations, variations, alternatives, and uses of the claimed invention, including what is presently believed to be the best mode of carrying out the claimed invention. Additionally, it is to be understood that the claimed invention is not limited in its application to the details of construction and the arrangements of components set forth in the following description or illustrated in the drawings. The claimed invention is capable of other embodiments and of being practiced or being carried out in various ways. Also, it is to be understood that the phraseology and terminology used herein is for the purpose of description and should not be regarded as limiting.

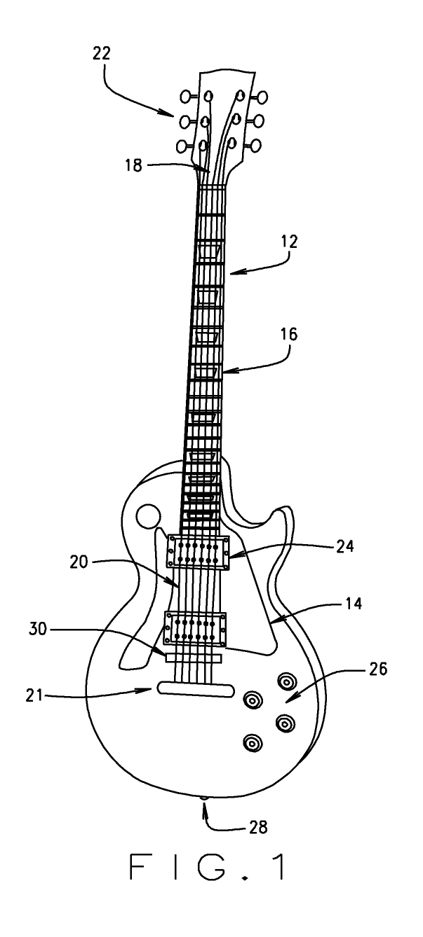

As shown in FIGS. 1-6, an embodiment constructed in accordance with the present disclosure, generally referred to as a tremolo assembly 10 is mounted to a stringed instrument, such as an electric guitar 12 to provide a tremolo effect when played. The electric guitar 12 includes a body 14 with a neck 16 extending therefrom and terminating in a head 18. (FIG. 1) Strings 20 attach to the head 18 with machine heads 22 and extend from the head 18 over and along the neck 16, body 14, a bridge 30, and a non-tremolo tailpiece 21 to the tremolo assembly 10. During play, a player moves the tremolo assembly 10 variably between a neutral position and tremolo effect positions to vary the tension and length of the strings temporarily, changing the pitch to create a vibrato, portamento, or pitch bend effect. In the neutral position, the tremolo assembly 10 generally does not affect the tension of the strings 20. In tremolo effect positions, the tremolo assembly 10 places varies the tension by either increasing or decreasing tension of the strings 20 to vary the pitch,

A pair of pick-ups 24 are attached to the body 14 underneath the strings 20. The pick-ups 24 are electrically connected to a power source and volume and tone controls 26. The pick-ups 24 electromagnetically communicate with the strings 20 to convert the strings vibration to an electrical signal. The pick-ups 24 communicate the electrical signal through the volume and tone controls 26 to an output jack 28. From the output jack 28, the electrical signal communicates, wire or wirelessly, with other audio components, such as an amplifier and speaker 29. Those skilled in the art will recognize that any number, position, and type of pick-ups 24 can be used, including, but not limited to, single-coil, double-coil, piezoelectric, or other electromagnetic arrangements.

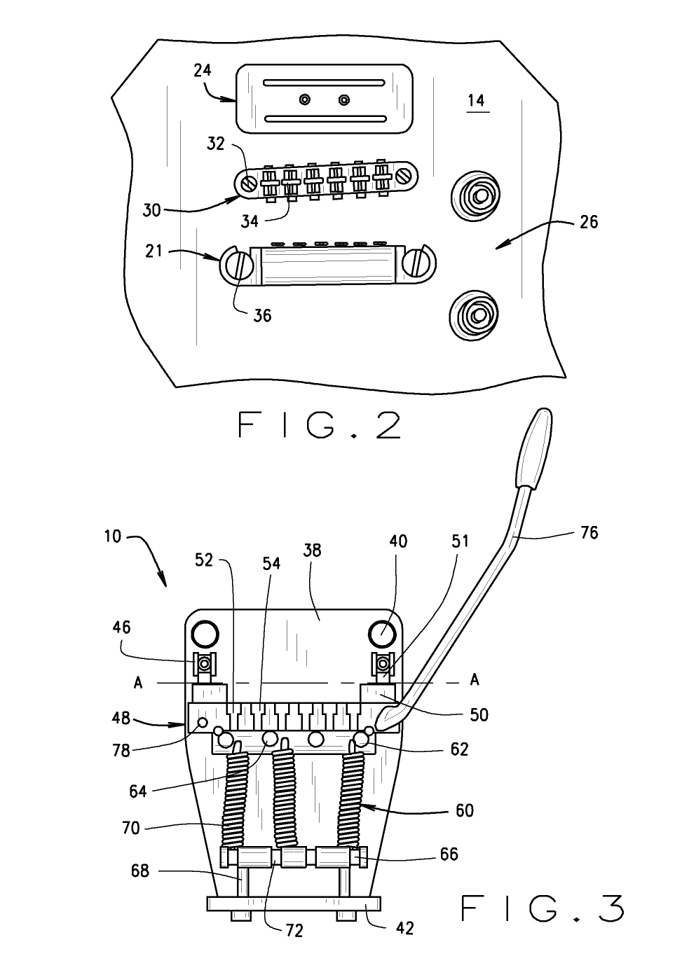

A bridge 30 attaches, such as with fasteners 32, to the body 14 generally between the pick-ups 24 and the tailpiece 21 for supporting and securing the strings 20. (FIG. 2) The bridge 30 includes a plurality of slots 34 shaped and sized for receiving and for supporting respective strings 20. Any suitable type of bridge can be used, such as, Gibson® original ABA, Gibson® Nashville ABA, Tone Pros® tune-o-matic, Schaller Nashville tune-o-matic and Gotoh tune-o-matic bridge.

The non-tremolo tailpiece 21 attaches to the body 14 with fasteners, such as threaded studs 36, by screwing the studs 36 into corresponding anchors (not shown) that have been pressed into to the body 14 in a position generally below the tailpiece 21. Each string 20 extends from the bridge 30 through a corresponding hole 39 defined in the tailpiece 21 to the tremolo assembly 10.

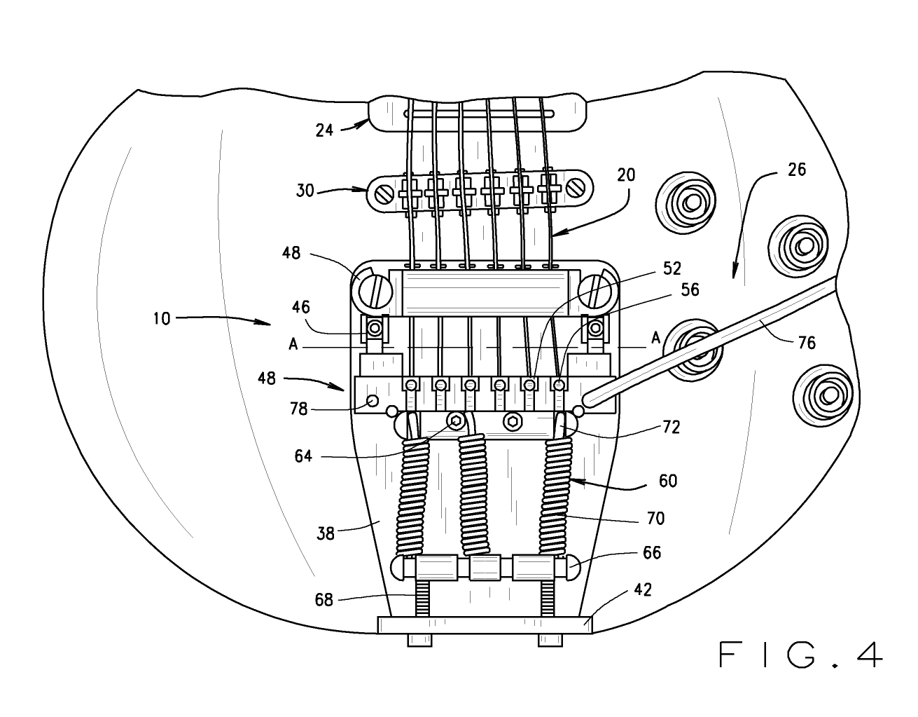

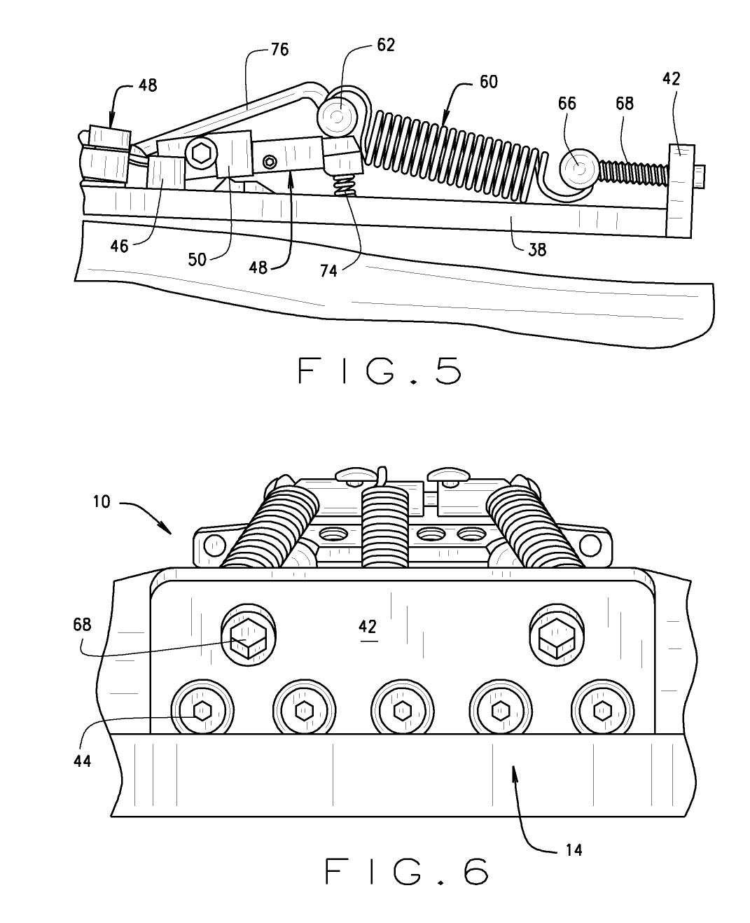

The tremolo assembly 10 includes a generally rectangular base plate 38 defining holes 40 at an upper end for mounting to the tailpiece 21. (FIG. 3) The instrument's original studs 36, extend through the tailpiece 21 and holes 40 for securement into the anchors in the body 14 so that the base plate 38 is clamped between the tailpiece 21 and the body 14 with the base plate 38 extending generally towards the lower end of the body 14. (FIG. 4). However, any suitable fastening means can be used in to attach the tailpiece 21 to the body 14, including, but not limited to other fasteners, welding, adhesives, and the like. The base plate 38 includes a generally rectangular end plate 42 attached, such as with fasteners 44, to the lower end of the base plate 38 in a generally perpendicular orientation relative to the base plate 38 (FIG. 6). Alternatively, the end plate 42 can be formed as an integral portion of the base plate 38.

A pair of hinges 46 attach to the base plate 38 in a position generally adjacent to the tailpiece 21 (FIG. 3). A generally rectangular string block 48 includes a tab 50 at both ends shaped and sized to pivotally attach to respective hinges 46 at pivot axis A-A, such as with fasteners 51, to provide variable movement of the string block 48 between the neutral position and the tremolo effect positions, the movement being generally towards and away from the body 14 about the pivot axis A-A. The tab 50 can attach to the string block 48 by any suitable means, such as welding, adhesive, or fastening. Alternatively, the tab 50 can be formed as an integral portion of the string block 48. The string block 48 defines a plurality of recesses shaped and sized to seat saddles 52. Each saddle 52 is a generally rectangular block that defines a bore 54 shaped and sized to receive an anchor member 56 located at the end of each string 20. (FIG. 3-4) To assemble, the anchor member 56 of each string 56 inserts into the bore 54 of the corresponding saddle 52. The string 20 extends through the tailpiece 21, over the bridge 30, body 14, pick-ups 24, neck 16 for attachment to the head 18 with machine heads 22, which also allows for adjustment of the tension on the string 20.

A biasing assembly 60 moveably attaches between the string block 48 and the end plate 42 and biases the movement of the string block 48 about the axis A-A between the neutral position and the tremolo effect positions. The biasing assembly 60 includes an upper member 62 attached to the string block 48, such as with fasteners 64, and a lower member 66 adjustably attached to the end plate 42, such as with fasteners 68. Biasing members 70, such as helical tension springs, attach between attachment points, such as slots 72, of the upper member 62 and lower member 66 and bias the upper member 62 about axis A-A (clockwise as shown in FIG. 5) generally towards the lower member 66. However, the biasing members 70 can attach between attachment points using any suitable means, including, but not limited to, a channel, a recess, groove, fasteners, welding, or adhesive. Adjustment of the fasteners 68 moves the lower member 66 closer or further from the upper member 62, thereby increasing or decreasing the bias of the biasing members 70. Although the embodiment of FIGS. 1-7, illustrates three biasing members 70, any number of biasing members can be used. In addition, any suitable type of biasing member can be substituted for the helical compression springs shown in the present embodiment, such as, elastic bands, cylinders, and the like. Furthermore, both the upper member 62 and lower member 66 are shown as cylindrical rods with slots 72 for receiving the biasing members 70. However, the upper and lower members 62 and 66 can comprise and suitable size and shape for adjustable connection between the biasing members 70 and the base plate end plate 42.

Auxiliary biasing members 74, such as helical compression springs, attach between the base plate 38 and a rear face of the string block 48, thereby, biasing the string block 48 away from the base plate 38 about pivot axis A-A (counter-clockwise as shown in FIG. 5). The force of the biasing members 70 and auxiliary biasing members 74 on the string block 48 about the axis A-A result in a net biasing force on the string block 48 about the pivot axis A-A in a clockwise direction as shown in FIG. 5, or generally towards the base plate 38.

A tremolo bar 76 moveably attaches to the string block 48, such as by inserting into one of two bores 78, which are located on each end of the string block 48 to accommodate both left-handed and right-handed players. In operation, when the player moves the tremolo bar 76 variably between the neutral position and the tremolo effect positions, while any of the strings are vibrating, a tremolo effect is produced by each of the vibrating strings.

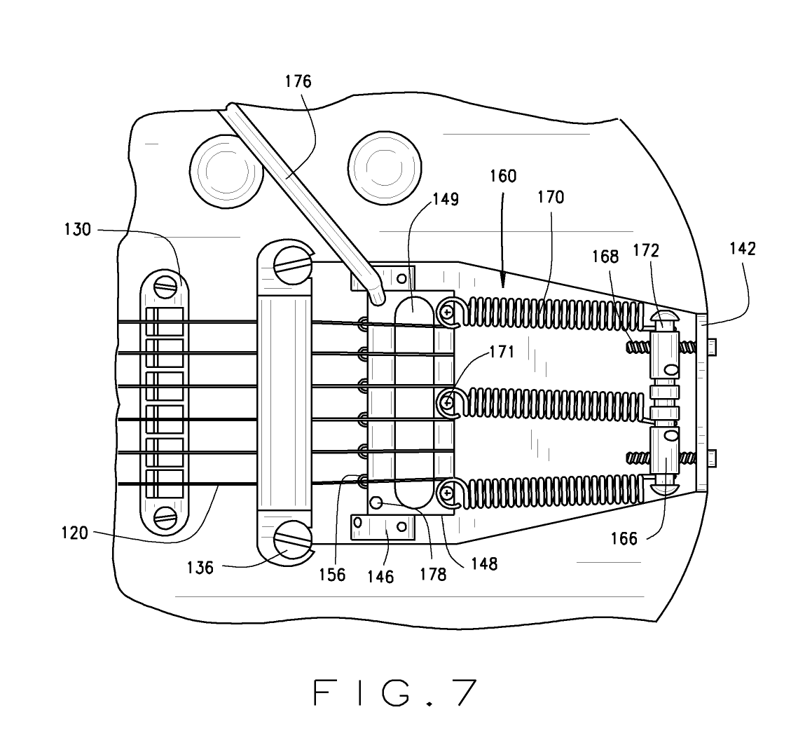

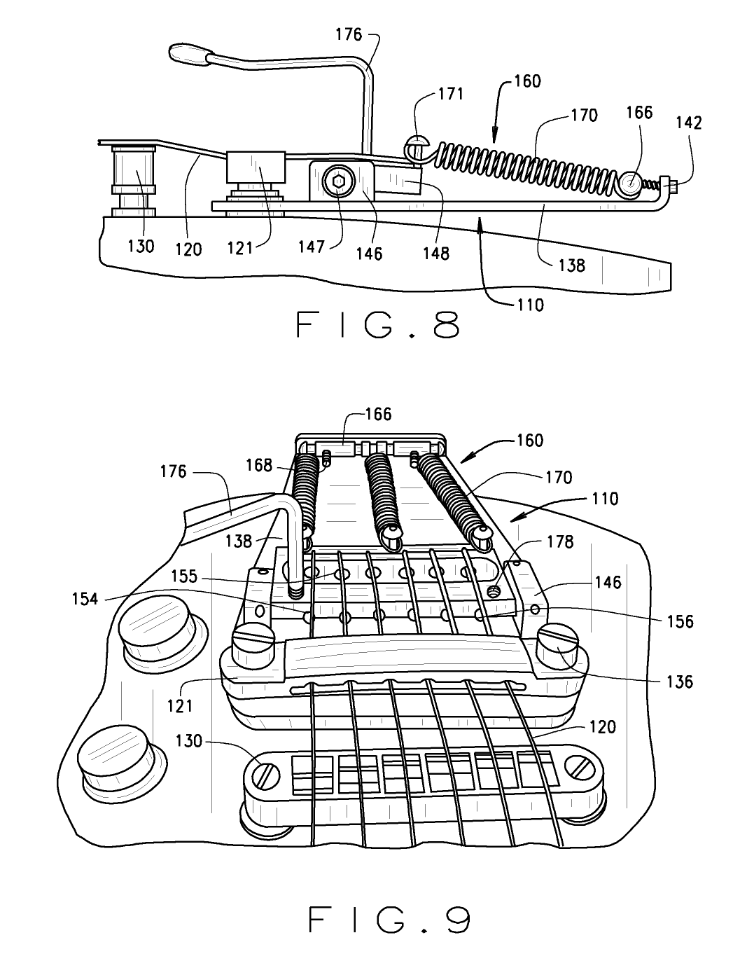

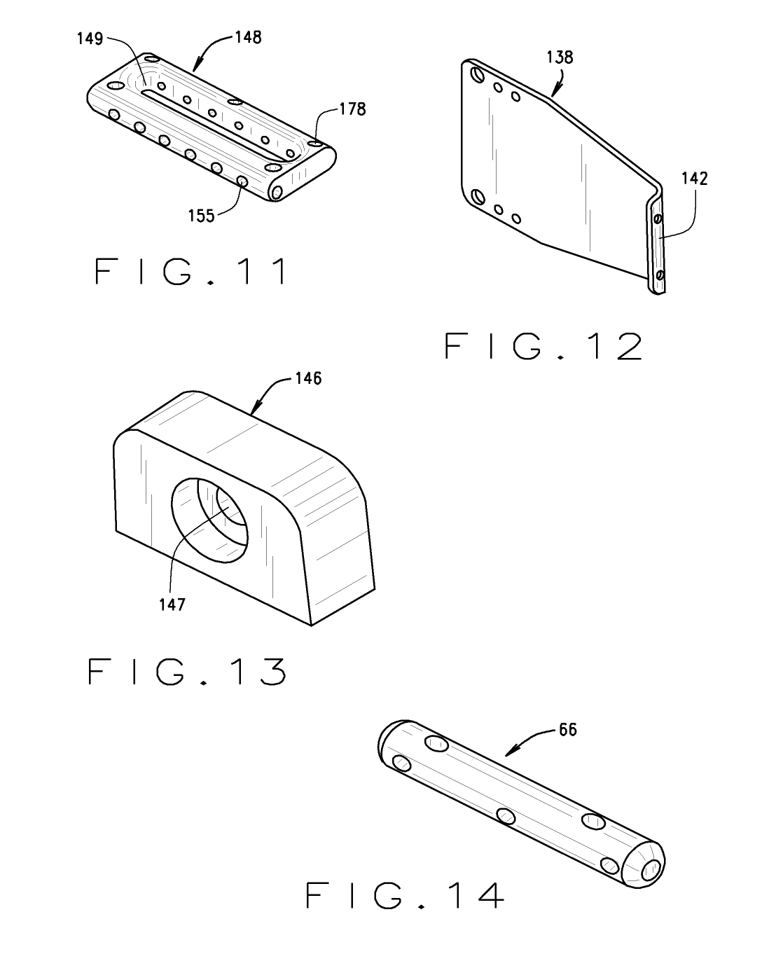

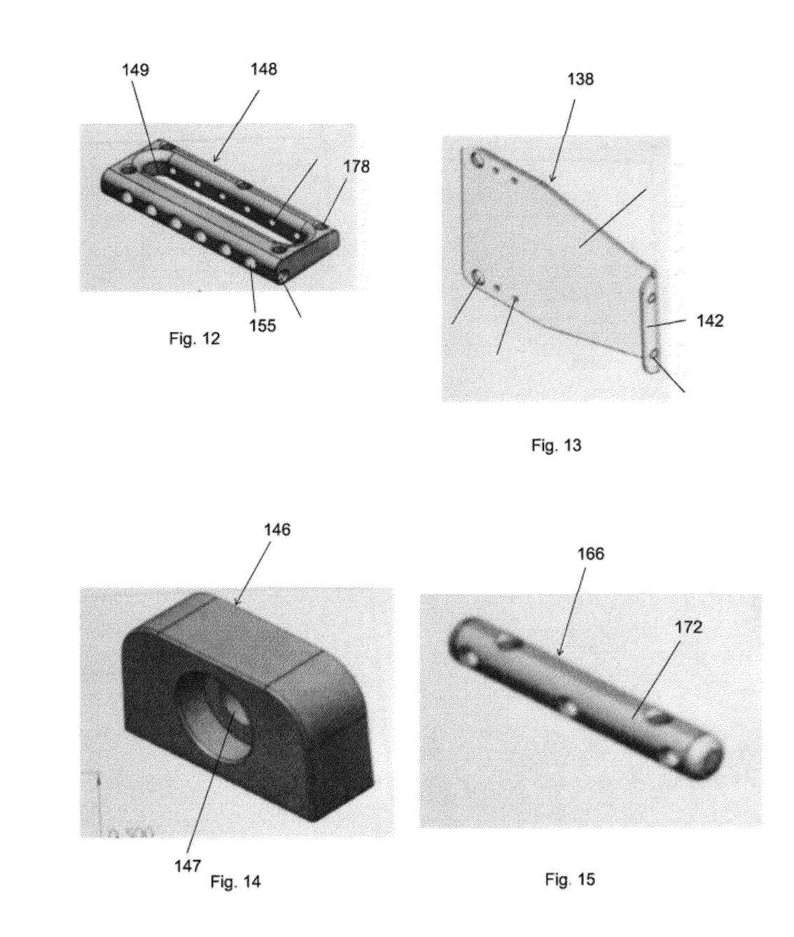

FIGS. 7-15 depict an alternate embodiment of the tremolo assembly 100, which is similar to the embodiment of FIGS. 1-6, but includes an alternate string block 148 and an alternate biasing assembly 160.

The tremolo assembly 100 is mounted to a stringed instrument, such as an electric guitar 112 to provide a tremolo effect when played. The electric guitar 112 includes a body 114 with a neck 116 extending therefrom and terminating in a head 118. (FIG. 7) Strings 120 attach to the head 118 with machine heads 122 and extend from the head 118 over and along the neck 116, body 114, a bridge 130, and a non-tremolo tailpiece 121 to the tremolo assembly 110. During play, a player moves the tremolo assembly 110 variably between a neutral position and a tremolo effect positions to vary the tension and length of the strings temporarily, changing the pitch to create a vibrato, portamento, or pitch bend effect.

A pair of pick-ups 124 are attached to the body 114 underneath the strings 120. The pick-ups 124 are electrically connected to a power source and volume and tone controls 126. The pick-ups 124 electromagnetically communicate with the strings 120 to convert the strings vibration to an electrical signal. The pick-ups 124 communicate the electrical signal through the volume and tone controls 126 to an output jack 128. From the output jack 128, the electrical signal communicates, wire or wirelessly, with other audio components, such as an amplifier and speaker. Those skilled in the art will recognize that any number, position, and type of pick-ups 124 can be used, including, but not limited to, single-coil, double-coil, piezoelectric, or other electromagnetic arrangements.

A bridge 130 attaches, such as with fasteners 132, to the body 114 generally between the pick-ups 124 and the tailpiece 121 for supporting and securing the strings 120. (FIG. 9) The bridge 130 includes a plurality of slots 134 for supporting respective strings 120. Any suitable type of bridge can be used, such as, Gibson® original ABA, Gibson® Nashville ABA, Tone Pros® tune-o-matic, Schaller Nashville tune-o-matic and Gotoh tune-o-matic bridge.

The non-tremolo tailpiece 121 attaches to the body 114 with fasteners, such as threaded studs 136, by screwing the studs 136 into corresponding anchors 137 that have been pressed into to the body 114 in a position generally below the tailpiece 121. Each string 120 extends from the bridge 130 through a corresponding hole 139 defined in the tailpiece 121 to the tremolo assembly 110. If needed, spacers can be positioned between the tailpiece 121 and the body 114 to enhance the fit.

The tremolo assembly 100 includes a generally rectangular base plate 138 defining holes 140 at an upper end for mounting to the tailpiece 21. (FIG. 9) The instrument's original studs 136, extend through the tailpiece 121 and holes 140 securing into the body 114 so that the base plate 138 is clamped between the tailpiece 121 and the body 114 with the base plate 138 extending generally towards the lower end of the body 114. However, any suitable fastening means can be used in to attach the tailpiece to the body 114, including, but not limited to other fasteners, welding, adhesives, and the like. A lower end of the base plate 138 includes an integral base plate 138 extending generally upwardly and in a generally perpendicular orientation relative to the base plate 138.

A pair of hinges 146 attach to respective edges of the base plate 138 in a position generally below the tailpiece 21. Each hinge 146 is a generally rectangular block that defines an opening or bore 174 for pivotal engagement about axis B-B to the alternate string block 148 using suitable connectors, such as fasteners, bearings, bushings, and the like (FIG. 14).

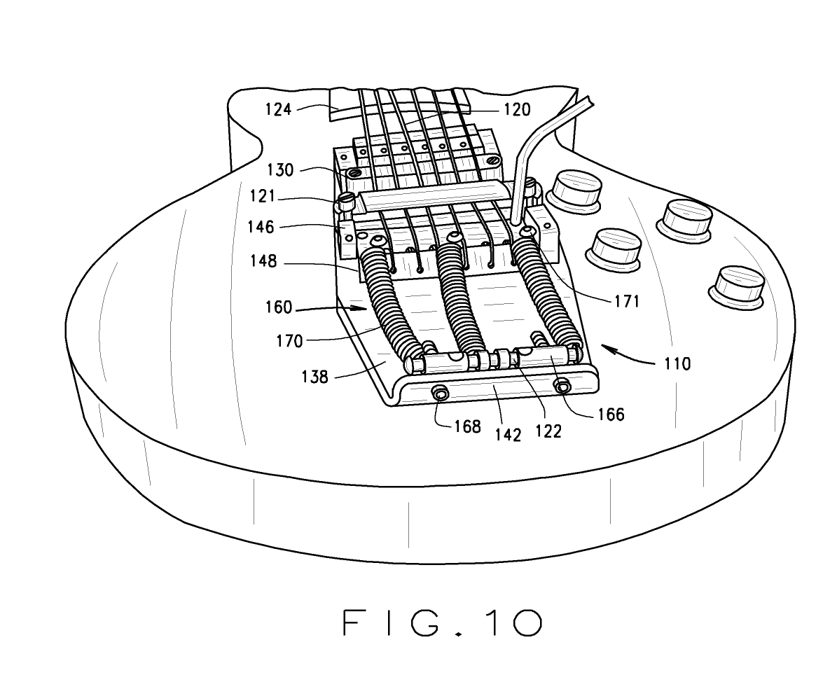

The alternate string block 148 defines a generally oblong opening 149, a plurality of upper bores 153 in an upper portion, and a corresponding plurality of lower bores 155 in a lower portion. Each lower bore 165 is sized and shaped to guide a respective string 120 to the upper bores 153. Each upper bore 153 is shaped and sized to receive an anchor member 156 located at the end of each string 120. (FIG. 10) The upper portion defines holes sized and shaped for pivotal attachment to the hinges 146 along axis B-B, such as with fasteners, bearings, or bushings.

To assemble, the anchor member 156 of each string 120 inserts into the upper bore 154 of the alternate string block 148. The string 120 extends through the lower bores 155, bends over the lower portion of the alternate string block 148, and extends back across the upper surface of the alternate string block 148, through the tailpiece 121, over the bridge 130, body 114, pick-ups 124, and neck 116 for attachment to the head 118 with machine heads 122, which also allow for adjustment of the tension on the string 120.

A biasing assembly 160 moveably attaches between the alternate string block 148 and the end plate 142 and biases the movement of the string block 148 about the axis B-B between the neutral position and the tremolo effect positions. The biasing assembly 160 includes a lower member 166 adjustably attached to the end plate 142, such as with fasteners 168. Biasing members 170, such as helical tension springs, attach between attachment points, such as with fasteners 164 of the alternate string block 148, and slots 172 of the lower member 166 to bias the alternate string block 148 about axis B-B (clockwise as shown in FIG. 11) and generally towards the lower member 166. However, the biasing members 170 can attach between attachment points using any suitable means, including, but not limited to, a channel, a recess, groove, fasteners, welding, or adhesive. Adjustment of the fasteners 168 moves the lower member 166 closer or further from the alternate string block 148, thereby increasing or decreasing the bias of the biasing members 170. Although the embodiment of FIGS. 7-15, illustrates three biasing members 170, any number of biasing members can be used. In addition, any suitable type of biasing member can be substituted for the helical compression springs shown in the present embodiment, such as, elastic bands. Furthermore, the lower member 166 is shown as a cylindrical rod with slots 172 for receiving the biasing members 170. However, the lower members 166 can comprise any suitable size and shape for adjustable connection between the biasing members 170 and the base plate 138.

The alternate embodiment of the tremolo assembly 100 does not require the use of auxiliary biasing members 74 as shown in the tremolo assembly 10 of FIGS. 1-6. However, if desired, auxiliary biasing members can be used in the alternate tremolo assembly 100 similar to the embodiment of FIGS. 1-6. If installed, auxiliary biasing members 74, such as helical compression springs, attach between the base plate 138 and a rear face of the string block 148, thereby, biasing the string block 148 away from the base plate 138 about pivot axis B-B (counter-clockwise). The force of the biasing members 170 and auxiliary biasing members 74 on the string block 148 about the axis B-B result in a net biasing force on the string block 148 about the pivot axis B-B in a clockwise direction, or generally towards the base plate 138.

A tremolo bar 176 moveably attaches to the string block 148, such as by inserting into one of the bores 178, which are located on each end of the string block 148 to accommodate both left-handed and right-handed players. In operation, when the player moves the tremolo bar variably between the neutral position and the tremolo effect positions, while any of the strings are vibrating, a tremolo effect is produced by each of the vibrating strings.

The tremolo assembly 110, except for the biasing members 170, is preferably made from brass. However, any other suitable material can be used.

Changes can be made in the above constructions without departing from the scope of the invention, it is intended that all matter contained in the above description or shown in the accompanying drawings shall be interpreted as illustrative and not in a limiting sense.

What is claimed is:

1. A tremolo assembly for a stringed instrument, comprising:
a base plate detachably mounted to the stringed instrument;
a string block operatively attached to the base plate for movement about an axis, the string block being shaped and sized for securement of strings;
a biasing mechanism attached between the string block and the base plate for biasing the string block about the axis;
a tremolo bar moveably attached to the string block for movement of the tremolo assembly between a neutral position and a tremolo effect position.

2. The tremolo assembly of claim 1, further comprising, a hinge attached between the string block and the base plate.

3. The tremolo assembly of claim 1, further comprising, an auxiliary biasing member attached between the stringed instrument and the string block for biasing the string block about the axis.

4. The tremolo assembly of claim 1, further comprising, an end plate attached to a lower end of the base plate.

5. The tremolo assembly of claim 1, further comprising, anchors detachably connected with the string block for securement of the strings.

6. The tremolo assembly of claim 1, the biasing mechanism comprising:
a lower member attached to the base plate, the lower member defining a connection point; and
a biasing member connected between the lower member and the string block.

7. The tremolo assembly of claim 5, wherein the lower member is adjustably attached to the base plate for increasing and decreasing the bias of the biasing member.

8. The tremolo assembly of claim 5, further comprising an upper member wherein attached to the spring block for receiving the biasing member.

9. A tremolo assembly for a musical instrument, the musical instrument having a body, a neck extending from the body, a head extending from the neck, and strings extending from the head along the neck to the body, comprising:
a base plate mounted to the body of the musical instrument;
a string block operatively attached to the base plate for movement about an axis, the string block being shaped and sized for securement of the strings;
a biasing mechanism attached between the string block and the base plate for biasing the string block about the axis; and
a tremolo bar moveably attached to the string block for movement of the tremolo assembly between a neutral position that generally does not affect the tension of the strings and a tremolo effect position that varies tension of the strings.

10. The tremolo assembly of claim 7, further comprising, a hinge attached between the string block and the base plate.

11. The tremolo assembly of claim 9, further comprising, an auxiliary biasing member attached between the body and the string block for biasing the string block about the pivot axis.

12. The tremolo assembly of claim 9, further comprising, an end plate attached to a lower end of the base plate.

13. The tremolo assembly of claim 9, further comprising, anchors detachably connected with the string block for securement of the strings.

14. The tremolo assembly of claim 9, the biasing mechanism comprising:
a lower member attached to the base plate, the lower member defining a connection point; and
a biasing member connected between the lower member and the string block.

15. The tremolo assembly of claim 14, wherein the lower member is adjustably attached to the base plate for increasing and decreasing the bias of the biasing member.

16. The tremolo assembly of claim 14, further comprising an upper member wherein attached to the spring block for receiving the biasing member.

17. A tremolo assembly for a stringed instrument, comprising:
a base plate detachably mounted to the stringed instrument;
a string block operatively attached to the base plate for movement about an axis, the string block being shaped and sized for securement of strings;
a biasing means attached between the string block and the base plate for biasing the string block about the axis;
a tremolo bar moveably attached to the string block for movement of the tremolo assembly between a neutral position and a tremolo effect position.
